(19) United States
(12) Patent Application Publication
(10) Pub. No.: US 2020/0257957 A1
(43) Pub. Date: Aug. 13, 2020

(54) SYSTEMS AND METHODS FOR CLASSIFYING EVENTS MONITORED BY SENSORS

(71) Applicant: GOPRO, INC., San Mateo, CA (US)

(72) Inventors: Daniel Tse, San Mateo, CA (US); Guanhang Wu, Changsha (CN); Desmond Chik, Mountain View, CA (US)

(21) Appl. No.: 15/435,241

(22) Filed: Feb. 16, 2017

(51) Int. Cl. G06N 3/04; G06N 3/08

(52) U.S. Cl. CPC G06N 3/04; G06N 3/082

(57) ABSTRACT

A set of sensor information conveyed by sensor output signals may be accessed. The sensor output signals may be generated by a set of sensors. The set of sensor information may characterize an event monitored by the set of sensors. A multi-feature convolutional neural network may be trained using a branch-loss function. The branch-loss function may include individual loss functions for individual sensor information and one or more combined loss functions for combined sensor information. The set of sensor information may be processed through the multi-feature convolutional neural network. A classification of the event may be obtained from the multi-feature convolutional network based on the set of sensor information.

### FIELD

This disclosure relates to systems and methods that classify events monitored by sensors.

### BACKGROUND

Convolutional neural networks may be trained to classify activities using multiple feature sources (e.g., image sensor, audio sensor) by concatenating features from the multiple features sources into a single combined feature and processing the single combined feature using a standard loss function. However, such training scheme fails to explicitly capture another piece of information that can improve training; that each individual feature source may have enough information to classify activities.

### SUMMARY

This disclosure relates to classifying events monitored by sensors. A set of sensor information conveyed by sensor output signals may be accessed. The sensor output signals may be generated by a set of sensors. The set of sensor information may characterize an event monitored by the set of sensors. The set of sensor information may be processed through a multi-feature convolutional neural network. The multi-feature convolutional neural network may be trained using a branch-loss function. The branch-loss function may include individual loss functions for individual sensor information and one or more combined loss functions for combined sensor information. A classification of the event may be obtained from the multi-feature convolutional network based on the set of sensor information.

A system that classifies events monitored by sensors may include one or more processors, and/or other components. The processor(s) may be configured by machine-readable instructions. Executing the machine-readable instructions may cause the processor(s) to facilitate classifying events monitored by sensors. The machine-readable instructions may include one or more computer program components. The computer program components may include one or more of an access component, a process component, an obtain component, and/or other computer program components.

The access component may be configured to access a set of sensor information conveyed by sensor output signals. The sensor output signals may be generated by a set of sensors. The set of sensor information may characterize an event monitored by the set of sensors. The set of sensor information may include first sensor information, second sensor information, and/or other sensor information. The first sensor information may be conveyed by first sensor output signals. The first sensor output signals may be generated by a first sensor. The first sensor information may characterize the event monitored by the first sensor. The second sensor information may be conveyed by second sensor output signals. The second sensor output signals may be generated by a second sensor. The second sensor information may characterize the event monitored by the second sensor.

In some implementations, the set of sensor information may further include third sensor information. The third sensor information may be conveyed by third sensor output signals. The third sensor output signals may be generated by a third sensor. The third sensor information may characterize the event monitored by the third sensor.

In some implementations, the first sensor information may include first visual information and/or other information. The first sensor output signals may include first visual output signals and/or other output signals. The first sensor may include a first image sensor and/or other sensors.

In some implementations, the second sensor information may include second visual information and/or other information. The second sensor output signals may include second visual output signals and/or other output signals. The second sensor may include a second image sensor and/or other sensors.

In some implementations, the second sensor information may include audio information and/or other information. The second sensor output signals may include audio output signals and/or other output signals. The second sensor may include an audio sensor and/or other sensors.

In some implementations, the second sensor information may include motion information and/or other information. The second sensor output signals may include motion output signals and/or other output signals. The second sensor may include an motion sensor and/or other sensors.

In some implementations, the second sensor information may include location information and/or other information. The second sensor output signals may include location output signals and/or other output signals. The second sensor may include an location sensor and/or other sensors.

The process component may be configured to process the set of sensor information through a multi-feature convolutional neural network. The multi-feature convolutional neural network may be trained using a branch-loss function. The branch-loss function may include individual loss functions for individual sensor information, one or more combined loss functions for combined sensor information, and/or other loss functions.

In some implementations, individual loss functions for individual sensor information may include a first sensor information loss function, a second sensor information loss function, and/or other sensor information loss function. The first sensor information loss function may include the first sensor information processed through a first fully connected layer, a second softmax layer, and a first loss function. The second sensor information loss function may include the second sensor information processed through a second fully connected layer, a second softmax layer, and a second loss function.

In some implementations, individual loss functions for the individual sensor information may further include a third sensor information loss function. The third sensor information loss function may include the third information processed through a third fully connected layer, a third softmax layer, and a third loss function.

In some implementations one or more of the first loss function, the second loss function, and the third loss function may include a cross-entropy loss function, a quadratic loss function, or an exponential loss function.

In some implementations, one or more combined loss functions for combined sensor information may include a first combined loss function and/or other combined loss function. The first combined loss function may include a combination of a first output of the first fully connected layer and a second output of the second fully connected layer processed through a first combined fully connected layer, a first combined softmax layer, and a first combined loss function.

In some implementations, one or more combined loss functions may further include a second combined loss function, a third combined loss function, and a fourth combined loss function. The second combined loss function may include a combination of the second output of the second fully connected layer and a third output of the third fully connected layer processed through a second combined fully connected layer, a second combined softmax layer, and a second combined loss function. The third combined loss function may include a combination of the first output of the first fully connected layer and the third output of the third fully connected layer processed through a third combined fully connected layer, a third combined softmax layer, and a third combined loss function. The fourth combined loss function may include a combination of the first output of the first fully connected layer, the second output of the second fully connected layer, and the third output of the third fully connected layer processed through a fourth combined fully connected layer, a fourth combined softmax layer, and a fourth combined loss function.

The obtain component may be configured to obtain a classification of the event from the multi-feature convolutional neural network. The classification of the event may be obtained based on the set of sensor information and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system that classifies events monitored by sensors.

FIG. 2 illustrates a method for classifying events monitored by sensors.

FIG. 3 illustrates exemplary branch-loss function for two features.

FIG. 4 illustrates exemplary branch-loss function for three features.

FIG. 5A illustrates exemplary branch-loss function equation for features A and B.

FIG. 5B illustrates exemplary branch-loss function equation for features A, B, and C.

FIG. 5C illustrates exemplary branch-loss function equation for features A, B, C, and D.

### DETAILED DESCRIPTION

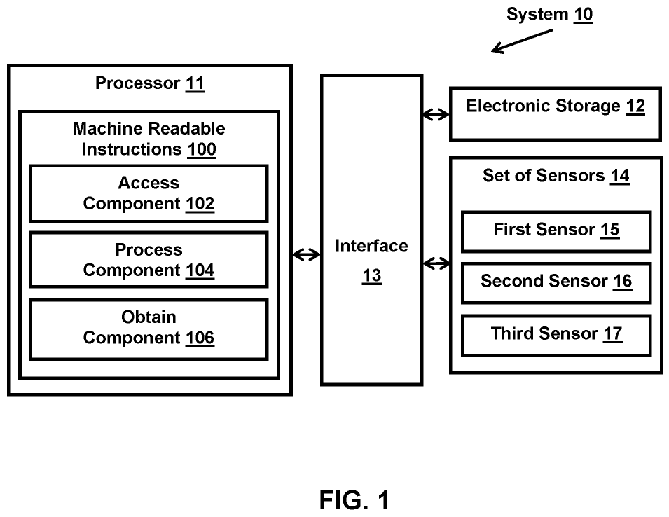

FIG. 1 illustrates system 10 for classifying events monitored by sensors. System 10 may include one or more of processor 11, storage media 12, interface 13 (e.g., bus, wireless interface), set of sensors 14, and/or other components. Set of sensors 14 may include first sensor 15, second sensor 16, and/or other sensors. In some implementations, set of sensors 14 may include third sensor 17. A set of sensor information conveyed by sensor output signals may be accessed by processor 11. The sensor output signals may be generated by set of sensors 14. The set of sensor information may characterize an event monitored by set of sensors 14. A multi-feature convolutional neural network may be trained using a branch-loss function. The branch-loss function may include individual loss functions for individual sensor information and one or more combined loss functions for combined sensor information. The set of sensor information may be processed through the multi-feature convolutional neural network. A classification of the event may be obtained from the multi-feature convolutional network based on the set of sensor information.

Electronic storage 12 may be configured to include electronic storage medium that electronically stores information. Electronic storage 12 may store software algorithms, information determined by processor 11, information received remotely, and/or other information that enables system 10 to function properly. For example, electronic 12 may store information relating to set of sensors 14, first sensor 15, second sensor 16, third sensor 17, sensor output signals, sensor information, multi-feature convolutional neural network, branch-loss function, classification of events, and/or other information.

Set of sensors 14 may be configured to generate sensor output signals conveying a set of sensor information. The set of sensor information may characterize an event monitored by set of sensors 14. Set of sensors 14 may include first sensor 15, second sensor 16, and/or other sensors. In some implementations, set of sensors 14 may include third sensor 17. Two or more sensors of set of sensors 14 may be located at same or different locations. For example, first sensor 15 and second sensor 16 may include the same type of sensor (e.g., image sensor) monitoring an event from the same location (e.g., located within a body of a camera and having different viewing directions/field of views of the event). First sensor 15 and second sensor 16 may include the same type of sensor (e.g., image sensor) monitoring an event from different locations (e.g., capturing visuals of the event from different locations). First sensor 15 and second sensor 16 may include different types of sensor (e.g., image sensor and motion sensor) monitoring an event from the same location (e.g., located within a body of a camera). First sensor 15 and second sensor 16 may include different type of sensors (e.g., image sensor and audio sensor) monitoring an event from different locations (e.g., capturing visuals and sounds of the event from different locations).

First sensor 15 may generate first sensor output signals. The first sensor output signals may convey first sensor information. The first sensor information may characterize the event monitored by first sensor 15. Second sensor 16 may generate second sensor output signals. The second sensor output signals may convey second sensor information. The second sensor information may characterize the event monitored by second sensor 16. Third sensor 17 may generate third sensor output signals. The third sensor output signals may convey third sensor information. The third sensor information may characterize the event monitored by third sensor 17.

One or more of first sensor 15, second sensor 16, third sensor 17, and/or other sensors may include an image sensor, an audio sensor, a motion sensor, a location sensor, and/or other sensors. An image sensor may generate visual output signals conveying visual information within the field of view of the image sensor. Visual information may define one or more images or videos of the event. An audio sensor may generate audio output signals conveying audio information. Audio information may define one or more audio/sound clips of the event. A motion sensor may generate motion output signals conveying motion information. Motion information may define one or more movements and/or orientations of the motion sensor/object monitored by the motion sensor (e.g., camera in which the motion sensor is located). A location sensor may generate location output signals conveying location information. The location information may define one or more locations of the location sensor/object monitored by the location sensor (e.g., camera in which the location sensor is located). Other types of sensors are contemplated.

Processor 11 may be configured to provide information processing capabilities in system 10. As such, processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 11 may be configured to execute one or more machine readable instructions 100 to facilitate classifying events monitored by sensors. Machine readable instructions 100 may include one or more computer program components. Machine readable instructions 100 may include one or more of access component 102, process component 104, obtain component 106, and/or other computer program components.

Access component 102 may be configured to access a set of sensor information conveyed by sensor output signals. Access component 102 may be configured to access the set of sensor information charactering the event monitored by set of sensors 14. Access component 102 may access one or more sensor information (e.g., visual information, audio information, motion information, location information) from one or more storage locations. A storage location may include electronic storage 12, electronic storage of one or more sensors, and/or other locations. For example, access component 102 may access visual information (from one or more image sensors) stored in storage media 12.

Access component 102 may be configured to access one or more sensor information during the acquisition of the sensor information and/or after the acquisition of the sensor information by one or more sensors. For example, access component 102 may access visual information defining an image while the image is being captured by one or more image sensors. Access component 102 may access visual information defining an image after the image has been captured and stored in memory (e.g., storage media 12).

Process component 104 may be configured to process the set of sensor information through a multi-feature convolutional neural network. Individual sensor information may provide individual features for processing by the multi-feature convolutional neural network. For example, visual sensor information may provide one or more images/videos as features for processing by the multi-feature convolutional neural network. Non-visual information (e.g., audio information, motion information, location information) may be converted into one or more visual representations (e.g., spectrogram) for processing by the multi-feature convolutional neural network. A multi-feature convolutional neural network may include a one-dimensional convolutional neural network, a two-dimensional convolutional neural network, a three-dimensional convolutional neural network, and/or a convolutional neural network of other dimensions.

The multi-feature convolutional neural network may be trained using a branch-loss function. The branch-loss function may include individual loss functions for individual sensor information, one or more combined loss functions for combined sensor information, and/or other loss functions. Training of the multi-feature convolutional neural network using a branch-loss function enables the multi-feature convolutional neural network to classify activities using one or more individual features, and/or one or more combined features. Training of the multi-feature convolutional neural network using a branch-loss function increases the accuracy of the classification performed by the multi-feature convolutional neural network.

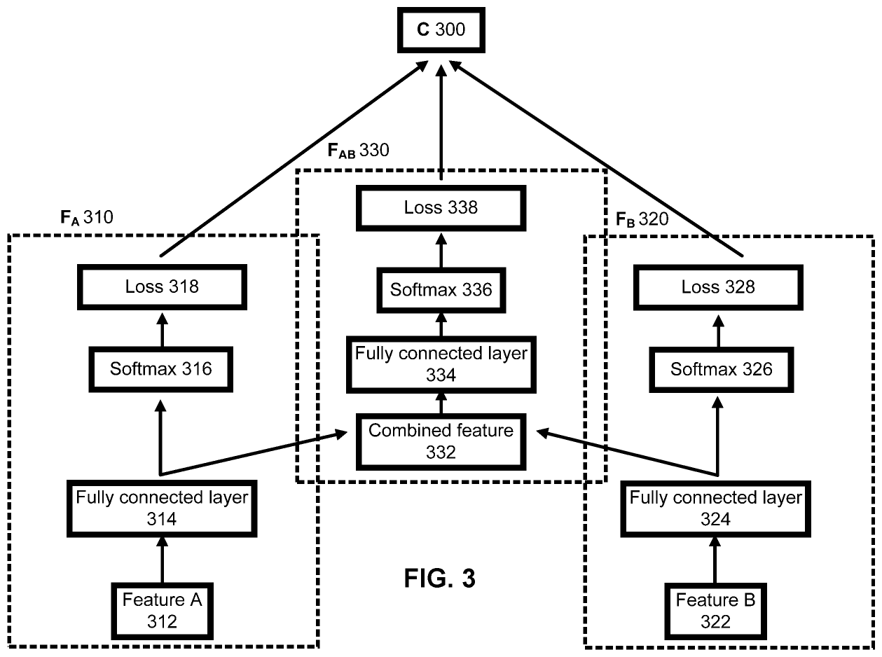

FIG. 3 illustrates exemplary branch-loss function C 300 for two features—feature A 312, feature B 322. Branch-loss function C 300 may include feature A loss function (F_{A} 310), feature B loss function (F_{B} 320), combined features A-B loss function (F_{AB} 330), and/or other loss functions. Feature A loss function (F_{A} 310) may include feature A 312 (including and/or derived from sensor information) processed through fully connected layer 314, softmax 316 and loss 318. Feature B loss function (F_{B} 320) may include feature B 322 (including and/or derived from sensor information) processed through fully connected layer 324, softmax 326 and loss 328.

Combined features A-B loss function (F_{AB} 330) may include a combination of outputs of fully connected layer 314 and fully connected layer 324 (combined features 332) processed through fully connected layer 334, softmax 336, and loss 338. One or more of losses 318, 328, 338 may include a cross-entropy loss, a quadratic loss, an exponential loss, and/or other loss.

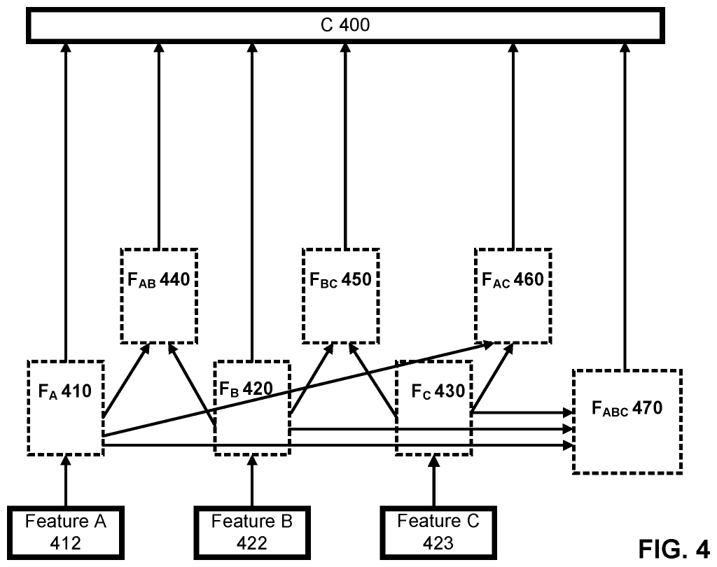

FIG. 4 illustrates exemplary branch-loss function C 400 for three features—feature A 412, feature B 422, feature C 432. Branch-loss function C 400 may include feature A loss function (F_{A} 410), feature B loss function (F_{B} 420), feature C loss function (F_{C} 430), combined features A-B loss function (F_{AB} 440), combined features B-C loss function (F_{BC} 450), combined features A-C loss function (F_{AC} 460), combined features A-B-C loss function (F_{ABC} 470) and/or other loss functions. Feature A loss function (F_{A} 410) may include feature A 412 (including and/or derived from sensor information) processed through a fully connected layer, a softmax layer, and a loss function. Feature B loss function (F_{B} 420) may include feature B 422 (including and/or derived from sensor information) processed through a fully connected layer, a softmax layer, and a loss function. Feature C loss function (F_{C} 430) may include feature C 432 (including and/or derived from sensor information) processed through a fully connected layer, a softmax layer, and a loss function.

Combined features A-B loss function (F_{AB} 440) may include a combination of outputs of the fully connected layer for feature A 412 and the fully connected layer for feature B 422 processed through a fully connected layer, a softmax layer, and a loss function. Combined features B-C loss function (F_{BC} 450) may include a combination of outputs of the fully connected layer for feature B 422 and the fully connected layer for feature C 432 processed through a fully connected layer, a softmax layer, and a loss function. Combined features A-C loss function (F_{AC} 460) may include a combination of outputs of the fully connected layer for feature A 412 and the fully connected layer for feature C 432 processed through a fully connected layer, a softmax layer, and a loss function. Combined features A-B-C loss function (F_{ABC} 470) may include a combination of outputs of the fully connected layer for feature A 412, the fully connected layer for feature B 422, and the fully connected layer for feature C 432 processed through a fully connected layer, a softmax layer, and a loss function. One or more loss functions may include a cross-entropy loss, a quadratic loss, an exponential loss, and/or other loss.

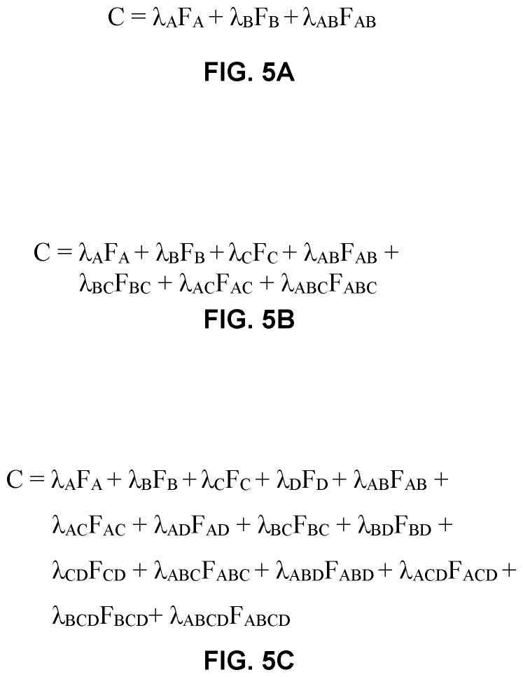

In some implementations, one or more weighing factors may be introduced into a branch loss function. Weighing factors may change the influence of different loss functions in a branch loss function. For example, FIG. 5A illustrates an exemplary equation for branch-loss function C 300 and FIG. 5B illustrates an exemplary equation for branch-loss function C 400. The equations for branch-loss function C 300, 400 may include one or more hyperparameters (A) that changes the influence of different loss functions (e.g., individual feature loss function, combined feature loss function). The impact of a particular loss function may be increased by increasing the corresponding hyperparameter and decreased by decreasing the corresponding hyperparameter.

The multi-feature convolutional neural networks may be trained using branch-loss functions for other numbers of features. For example, FIG. 5C illustrates an exemplary equation for branch-loss function for four features—feature A, feature B, feature C, and feature D.

Obtain component 106 may be configured to obtain a classification of the event from the multi-feature convolutional neural network. The classification of the event may be obtained based on the set of sensor information (e.g., features) and/or other information. Classification of the event may equal/be obtained from (at inference time) softmax values (e.g., values of softmax 336, values of softmax of F_{ABC} 470). A classification of an event obtained from a multi-feature convolutional neural network may have greater accuracy than a classification of an event obtained from a convolutional neural network trained using standard loss functions for concatenated features.

For example, a person may be surfing while using multiple sensors to monitor the surfing activity. Multiple sensors used by the surfer may include a camera mounted on the surfing board and/or a camera mounted on the person's body (e.g., head or chest-mounted camera). One or both of the cameras may additionally include one or more audio sensors to record sounds, motion sensors to measure motion of the person/surfboard, location sensors to identify locations of the person/surfboard, and/or other sensors. The multi-feature convolutional neural network trained using a branch loss function (for two or more of visual features, audio features, motion features, location features, other features), which processes multiple features for classification, may more accurately classify the person's activity as “surfing” than a convolutional neural network trained using a standard loss function (for concatenated features), which processes concatenated features for classification. Uses of other sensors/sensor information and identification of other activities by the multi-feature convolutional neural network are contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although processor 11 and electronic storage 12 are shown to be connected to interface 13 in FIG. 1, any communication medium may be used to facilitate interaction between any components of system 10. One or more components of system 10 may communicate with each other through hard-wired communication, wireless communication, or both. For example, one or more components of system 10 may communicate with each other through a network. For example, processor 11 may wirelessly communicate with electronic storage 12. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor 11 is shown in FIG. 1 as a single entity, this is for illustrative purposes only. In some implementations, processor 11 may comprise a plurality of processing units. These processing units may be physically located within the same device, or processor 11 may represent processing functionality of a plurality of devices operating in coordination. Processor 11 may be configured to execute one or more components by software; hardware; firmware; some combination of software, hardware, and/or firmware; and/or other mechanisms for configuring processing capabilities on processor 11.

It should be appreciated that although computer components are illustrated in FIG. 1 as being co-located within a single processing unit, in implementations in which processor 11 comprises multiple processing units, one or more of computer program components may be located remotely from the other computer program components.

The description of the functionality provided by the different computer program components described herein is for illustrative purposes, and is not intended to be limiting, as any of computer program components may provide more or less functionality than is described. For example, one or more of computer program components 102, 104, and/or 106 may be eliminated, and some or all of its functionality may be provided by other computer program components. As another example, processor 11 may be configured to execute one or more additional computer program components that may perform some or all of the functionality attributed to one or more of computer program components 102, 104, and/or 106 described herein.

The electronic storage media of electronic storage 12 may be provided integrally (i.e., substantially non-removable) with one or more components of system 10 and/or removable storage that is connectable to one or more components of system 10 via, for example, a port (e.g., a USB port, a Firewire port, etc.) or a drive (e.g., a disk drive, etc.). Electronic storage 12 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 12 may be a separate component within system 10, or electronic storage 12 may be provided integrally with one or more other components of system 10 (e.g., processor 11). Although electronic storage 12 is shown in FIG. 1 as a single entity, this is for illustrative purposes only. In some implementations, electronic storage 12 may comprise a plurality of storage units. These storage units may be physically located within the same device, or electronic storage 12 may represent storage functionality of a plurality of devices operating in coordination.

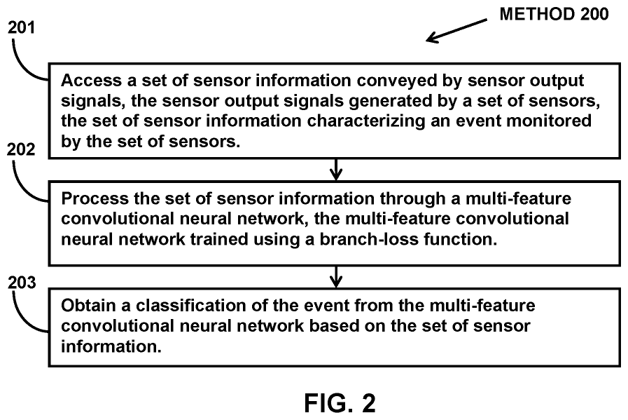

FIG. 2 illustrates method 200 for classifying events monitored by sensors. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage mediums. The one or more processing devices may include one or more devices configured through hardware, firmware, and/or software to be specifically designed for execution of one or more of the operation of method 200.

Referring to FIG. 2 and method 200, at operation 201, a set of sensor information conveyed by sensor output signals may be accessed. The sensor output signals may be generated by a set of sensors. The set of sensor information may characterize an event monitored by the set of sensors. The set of sensor information may include first sensor information and second sensor information. The first sensor information may be conveyed by first sensor output signals. The first sensor output signals may be generated by a first sensor. The first sensor information may characterize the event monitored by the first sensor. The second sensor information may be conveyed by second sensor output signals. The second sensor output signals may be generated by a second sensor. The second sensor information may characterize the event monitored by the second sensor. In some implementation, operation 201 may be performed by a processor component the same as or similar to access component 102 (Shown in FIG. 1 and described herein).

At operation 202, the set of sensor information may be processed through a multi-feature convolutional neural network. The multi-feature convolutional neural network may be trained using a branch-loss function. The branch-loss function may include individual loss functions for individual sensor information and one or more combined loss functions for combined sensor information. In some implementations, operation 202 may be performed by a processor component the same as or similar to process component 104 (Shown in FIG. 1 and described herein).

At operation 203, a classification of the event may be obtained from the multi-feature convolutional neural network. The classification may be obtained based on the set of sensor information. In some implementations, operation 203 may be performed by a processor component the same as or similar to obtain component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for classifying events monitors by sensors, the system comprising:
one or more physical processors configured by machine-readable instructions to:
access a set of sensor information conveyed by sensor output signals, the sensor output signals generated by a set of sensors, the set of sensor information characterizing an event monitored by the set of sensors, wherein the set of sensor information includes:
first sensor information conveyed by first sensor output signals, the first sensor output signals generated by a first sensor, the first sensor information characterizing the event monitored by the first sensor; and
second sensor information conveyed by second sensor output signals, the second sensor output signals generated by a second sensor, the second sensor information characterizing the event monitored by the second sensor;
process the set of sensor information through a multi-feature convolutional neural network, the multi-feature convolutional neural network trained using a branch-loss function, wherein the branch-loss function includes individual loss functions for individual sensor information and one or more combined loss functions for combined sensor information; and
obtain a classification of the event from the multi-feature convolutional neural network based on the set of sensor information,
wherein:
the individual loss functions for the individual sensor information includes a first sensor information loss function and a second sensor information loss function, the first sensor information loss function including the first sensor information processed through a first fully connected layer, a first softmax layer, and a first loss function, and the second sensor information loss function including the second sensor information processed through a second fully connected layer, a second softmax layer, and a second loss function; and
the one or more combined loss functions for combined sensor information include a first combined loss function, a first output of the first fully connected layer for the first sensor information loss function and a second output of the second fully connected layer for the second sensor information loss information combined as a first combined feature for the first combined loss function, the first combined loss function including the first combined feature processed through a first combined fully connected layer, a first combined softmax layer, and a first combined loss function.

2. (canceled)

3. (canceled)

4. The system of claim 1, wherein:
the set of sensor information further includes third sensor information conveyed by third sensor output signals, the third sensor output signals generated by a third sensor, the third sensor information characterizing the event monitored by the third sensor;
the individual loss functions for the individual sensor information further includes a third sensor information loss function, the third sensor information loss function including the third information processed through a third fully connected layer, a third softmax layer, and a third loss function; and
the one or more combined loss functions further include:
a second combined loss function, the second output of the second fully connected layer for the second sensor information loss function and a third output of the third fully connected layer for the third sensor information loss function combined as a second combined feature for the second combined loss function, the second combined loss function including the second combined feature processed through a second combined fully connected layer, a second combined softmax layer, and a second combined loss function;
a third combined loss function, the first output of the first fully connected layer for the first sensor information loss function and the third output of the third fully connected layer for the third sensor information loss function combined as a third combined feature for the third combined loss function, the third combined loss function including the third combined feature processed through a third combined fully connected layer, a third combined softmax layer, and a third combined loss function; and
a fourth combined loss function, the first output of the first fully connected layer for the first sensor information loss function, the second output of the second fully connected layer for the second sensor information loss function, and the third output of the third fully connected layer for the third sensor information loss function combined as a fourth combined feature for the fourth combined loss function, the fourth combined loss function including the fourth combined feature processed through a fourth combined fully connected layer, a fourth combined softmax layer, and a fourth combined loss function.

5. The system of claim 1, wherein the first loss function includes a cross-entropy loss function, a quadratic loss function, or an exponential loss function.

6. The system of claim 1, wherein the first sensor information includes first visual information, the first sensor output signals include first visual output signals, and the first sensor includes a first image sensor.

7. The system of claim 6, wherein the second sensor information includes second visual information, the second sensor output signals include second visual output signals, and the second sensor includes a second image sensor.

8. The system of claim 6, wherein the second sensor information includes audio information, the second sensor output signals include audio output signals, and the second sensor includes an audio sensor.

9. The system of claim 6, wherein the second sensor information includes motion information, the second sensor output signals include motion output signals, and the second sensor includes a motion sensor.

10. The system of claim 6, wherein the second sensor information includes location information, the second sensor output signals include location output signals, and the second sensor includes a location sensor.

11. A method for classifying events monitors by sensors, the method implemented in a system including one or more physical processors, the method comprising:
accessing, by the one or more physical processors, a set of sensor information conveyed by sensor output signals, the sensor output signals generated by a set of sensors, the set of sensor information characterizing an event monitored by the set of sensors, wherein the set of sensor information includes:
first sensor information conveyed by first sensor output signals, the first sensor output signals generated by a first sensor, the first sensor information characterizing the event monitored by the first sensor; and
second sensor information conveyed by second sensor output signals, the second sensor output signals generated by a second sensor, the second sensor information characterizing the event monitored by the second sensor;
processing, by the one or more physical processors, the set of sensor information through a multi-feature convolutional neural network, the multi-feature convolutional neural network trained using a branch-loss loss function, wherein the branch-loss loss function includes individual loss functions for individual sensor information and one or more combined loss functions for combined sensor information; and
obtaining, by the one or more physical processors, a classification of the event from the multi-feature convolutional neural network based on the set of sensor information,
wherein:
the individual loss functions for the individual sensor information includes a first sensor information loss function and a second sensor information loss function, the first sensor information loss function including the first sensor information processed through a first fully connected layer, a first softmax layer, and a first loss function, and the second sensor information loss function including the second sensor information processed through a second fully connected layer, a second softmax layer, and a second loss function; and
the one or more combined loss functions for combined sensor information include a first combined loss function, a first output of the first fully connected layer for the first sensor information loss function and a second output of the second fully connected layer for the second sensor information loss information combined as a first combined feature for the first combined loss function, the first combined loss function including the first combined feature processed through a first combined fully connected layer, a first combined softmax layer, and a first combined loss function.

12. (canceled)

13. (canceled)

14. The method of claim 11, wherein:
the set of sensor information further includes third sensor information conveyed by third sensor output signals, the third sensor output signals generated by a third sensor, the third sensor information characterizing the event monitored by the third sensor;
the individual loss functions for the individual sensor information further includes a third sensor information loss function, the third sensor information loss function including the third information processed through a third fully connected layer, a third softmax layer, and a third loss function; and
the one or more combined loss functions further include:
a second combined loss function, the second output of the second fully connected layer for the second sensor information loss function and a third output of the third fully connected layer for the third sensor information loss function combined as a second combined feature for the second combined loss function, the second combined loss function including the second combined feature processed through a second combined fully connected layer, a second combined softmax layer, and a second combined loss function;
a third combined loss function, the first output of the first fully connected layer for the first sensor information loss function and the third output of the third fully connected layer for the third sensor information loss function combined as a third combined feature for the third combined loss function, the third combined loss function including the third combined feature processed through a third combined fully connected layer, a third combined softmax layer, and a third combined loss function; and
a fourth combined loss function, the first output of the first fully connected layer for the first sensor information loss function, the second output of the second fully connected layer for the second sensor information loss function, and the third output of the third fully connected layer for the third sensor information loss function combined as a fourth combined feature for the fourth combined loss function, the fourth combined loss function including the fourth combined feature processed through a fourth combined fully connected layer, a fourth combined softmax layer, and a fourth combined loss function.

15. The method of claim 11, wherein the first loss function includes a cross-entropy loss function, a quadratic loss function, or an exponential loss function.

16. The method of claim 11, wherein the first sensor information includes first visual information, the first sensor output signals include first visual output signals, and the first sensor includes a first image sensor.

17. The method of claim 16, wherein the second sensor information includes second visual information, the second sensor output signals include second visual output signals, and the second sensor includes a second image sensor.

18. The method of claim 16, wherein the second sensor information includes audio information, the second sensor output signals include audio output signals, and the second sensor includes an audio sensor.

19. The method of claim 16, wherein the second sensor information includes motion information, the second sensor output signals include motion output signals, and the second sensor includes a motion sensor.

20. The method of claim 16, wherein the second sensor information includes location information, the second sensor output signals include location output signals, and the second sensor includes a location sensor.
